(19) United States
(12) Patent Application Publication
(10) Pub. No.: US 2014/0318064 A1
(43) Pub. Date: Oct. 30, 2014

(54) PRESS-ON RETAINER FOR FIRE-STOPPING SLEEVE

(71) Applicant: Russell William Reinhardt, Hermitage, PA (US)

(72) Inventor: Russell William Reinhardt, Hermitage, PA (US)

(21) Appl. No.: 14/253,033

(22) Filed: Apr. 15, 2014

Related U.S. Application Data
(60) Provisional application No. 61/816,040, filed on Apr. 25, 2013.

(51) Int. Cl. E04B 1/94; F16L 5/04

(52) U.S. Cl. CPC E04B 1/947; F16L 5/04
USPC 52/317; 52/698

(57) ABSTRACT

A press-on retainer is configured to retain a fire-stop sleeve in an opening. The retainer includes a body formed of sheet metal. The body is configured to define a concave shape, a hole in the body, and a plurality of segments extending radially from the hole. Each segment is includes an angled portion at the end of the segment that defines the hole with a diameter suitable to accept the sleeve. The angled portions are configured to allow the retainer to be pressed onto the sleeve in a first direction, and thereafter prevent the retainer from being moved in a second direction opposite the first direction.

### CROSS-REFERENCE TO RELATED APPLICATION

This application claims the benefit under 35 U.S.C. §119(e) of U.S. Provisional Patent Application No. 61/816,040, filed Apr. 25, 2013, the entire disclosure of which is hereby incorporated herein by reference.

### TECHNICAL FIELD OF INVENTION

This disclosure generally relates to a press-on retainer for a fire-stop sleeve, and more particularly relates to an angled portion or the retainer that improves the process of installing the retainer on the sleeve.

### BACKGROUND OF INVENTION

It is often necessary for electric signal carrying cables to pass through walls of buildings. Often, the walls are constructed to provide a fire-stop that slows the spreading of fire from one side of the wall to the other side, e.g. from a garage attached to a house to the interior of the house. If a hole or opening is made in the wall to provide a pass through for one or more of these cables, the fire-stopping performance of the wall may be reduced. Various fire stopping appliances positionable within an opening of a wall for fire stop sealing around cables, wires or other longitudinal members which would otherwise be required to extend through the wall area have been proposed. Such fire-stopping fixtures include various types of sleeves placed through the wall, retainers on either side of the wall to hold the sleeve in place, and various sealing material placed within the sleeves after the cables are positioned therein. However, many of the retainers proposed are formed of multiple parts that require time consuming assembly to install, and have complicated features that undesirable increase the manufacturing cost of the retainer.

### SUMMARY OF THE INVENTION

In accordance with one embodiment, a press-on retainer to retain a fire-stop sleeve in an opening is provided. The retainer includes a body formed of sheet metal. The retainer is configured to have a concave shape and define a hole in the body and a plurality of segments extending radially from the hole. Each segment includes an angled portion at the end of the segment that defines the hole with a diameter suitable to accept the sleeve. The angled portions are configured to allow the retainer to be pressed onto the retainer in a first direction, and prevent the retainer from being moved in a second direction opposite the first direction.

In another embodiment, the retainer includes slots extending radially from the hole define the plurality of segments, and each slot includes a stress relief feature at the end of each slot.

In another embodiment, a fire-stop kit is provided. The fire-stop kit includes a fire-stop sleeve, and a press-on retainer. The retainer is configured to retain the fire-stop sleeve in an opening. The retainer includes a body formed of sheet metal. The body is configured to define a concave shape, a hole in the body, and a plurality of segments extending radially from the hole. Each segment is includes an angled portion at the end of the segment that defines the hole with a diameter suitable to accept the sleeve. The angled portions are configured to allow the retainer to be pressed onto the sleeve in a first direction, and thereafter prevent the retainer from being moved in a second direction opposite the first direction.

In another embodiment, the fire-stop kit includes a second retainer.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a cut-away perspective view of a fire-stop kit prior to installation into a wall in accordance with one embodiment;

FIG. 2 is a cut-away perspective view of a fire-stop kit after installation into a wall in accordance with one embodiment; and

FIG. 3 is a perspective view of a retainer used in the fire stop kit of FIGS. 1 and 2 in accordance with one embodiment.

### DETAILED DESCRIPTION

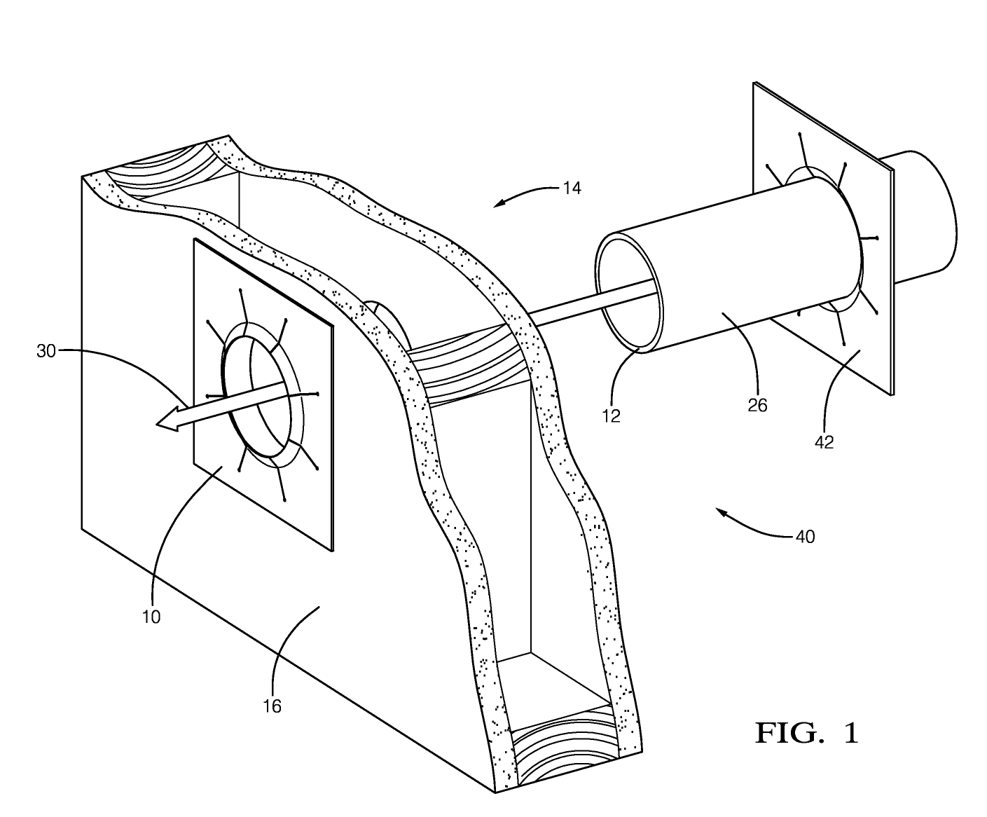

FIG. 1 illustrates a non-limiting example of a press-on retainer, hereafter the retainer 10, prior to being installed onto a fire-stop sleeve, hereafter the sleeve 12. The retainer 10 and the sleeve 12 may form, or be part of, a fire-stop kit 40. The kit 40 may include a second retainer 42 so that the sleeve 12 is held in place after installing the retainer 10 and the second retainer 42 in the orientations shown. In this non-limiting example the second retainer 42 is shown already pressed onto the sleeve 12 prior to inserting the sleeve into a wall 16 in the direction indicated by arrow 30. Alternatively, the sleeve 12 may be installed into the wall 16, and then the retainer 10 and the second retainer 42 are pressed into place.

The wall 16 illustrated in this example is commonly called a stud wall, and is typically constructed of a 2×4 framework with drywall attached to each side of the framework, as will be recognized by those in the art. Alternatively, the wall may be brick, poured concrete, or any other type of wall that could benefit from smoke/fire propagation prevention afforded by the kit 40 if a hole or opening 14 through the wall 16 is needed to, for example, pass cables 44, wires, and the like.

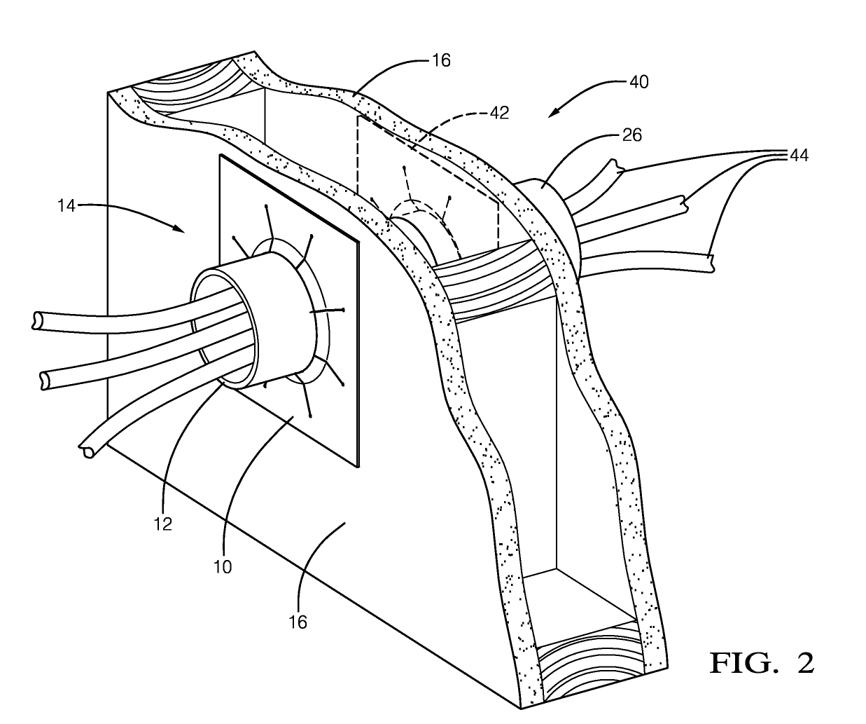

FIG. 2 illustrates a non-limiting example of the kit 40 after being installed into the wall 16. While not specifically shown, it is recognized that the kit 40 may also include fire stop foam or fire stop putty placed around the cables 44 to seal the interior of the sleeve 12 and thereby resist smoke from passing through the wall 16 via inside of the sleeve 12. It is also recognized that fire stop foam, fire stop putty, or other suitable material may be applied between the exterior of the sleeve 12 and the wall 16 to further resist the propagation of fire and/or smoke through the wall 16. The application of such additional materials may be necessary to comply with local building codes or best practices recommended by testing organizations such as Underwriters Laboratories Inc.

The sleeve 12 is illustrated as a unitary part without seams or other non-uniformities. However, it is contemplated that the sleeve 12 may have a weld seam, or may be formed of sheet metal joined along the length of the sleeve 12 by a folded joint. Alternatively, the sleeve 12 may be formed of two longitudinal halves held together by the retainer 10, or the sleeve 12 may be formed of several layers of sheet metal rolled up to a desired diameter in a way similar to paper being formed into a tube by rolling. As will be recognized by those in the art, suitable diameters for the sleeve are twenty five to fifty millimeters (25 mm-50 mm), but these dimensions are not limits on the range of diameters.

In general, the kit 40 is installed when electric signal carrying cables pass through the walls of buildings. Often, the walls are constructed to provide a fire-stop that slows the spreading of fire from one side of the wall to the other side, e.g. from a garage attached to a house to the interior of the house. Without the kit 40 properly installed in accordance with local building codes or best practices, fire and/or smoke may more quickly breach the wall 16. However, in order to reduce construction material costs, reducing the complexity of a fire stop kit can advantageously reduce the cost of properly constructing a wall that is intended to act as at least a temporary fire barrier. Furthermore, a fire stop kit that does not require tools to install is preferable. That is, a fire stop kit that can be installed easily using only hands (i.e. without tools) can reduce the installation time and thereby save on construction labor costs.

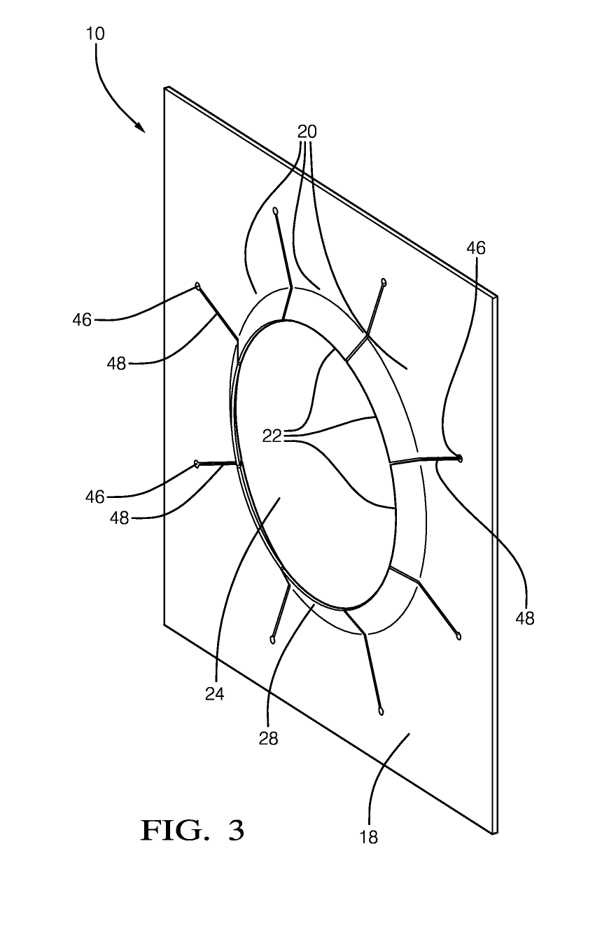

FIG. 3 shows further details of a press-on retainer (the retainer 10) prior to pressing the retainer onto the sleeve 12. As will be describe in more detail, the retainer 10 that provides the desirable advantages noted above when compared to previous examples of fire stop kits with differently configured retainers such as those available from Graybar Services Inc. and 3M. In general, the retainer 10 is configured to retain the sleeve 12 in an opening 14 through a wall (e.g. the wall 16). Whatever the configuration of the sleeve 12, the retainer 10 is configured to be pressed onto the sleeve 12 with an interference fit so that once installed, the retainer 10 is not readily removed from the sleeve 12 without deforming some of the features of the retainer 10 to disengage those features from the sleeve 12, as will become apparent in the further description below.

The outline of the retainer 10 is generally defined or determined by a body 18, preferably formed of sheet metal. By way of example and not limitation, a suitable sheet metal for forming the retainer 10 is one millimeter (1.0 mm) thick #310 steel. In general, the body 18 has a concave shape. That is, the retainer 10 is not flat, even before the retainer 10 is installed onto the sleeve 12. The retainer 10 or the body 18 is further configured to define a hole 24 in the body, and a plurality of segments 20 extending radially from the hole 24. Each of the segments 20 is includes an angled portion 28 at the inner ends 22 of the segments 20 that cooperate to define the hole 24 with a diameter suitable to accept the sleeve 12. The angled portion 28 also helps to shorten the portion of the segments 20 that do not receive supporting contact with the wall through which the sleeve 12 is installed, shown in this non-limiting example as the wall 16. Reducing the unsupported portion generally increases the amount of force needed to deform the segments 20 in a manner that would allow the retainer 10 to be removed from the sleeve 12 in a direction opposite of the installation direction shown by arrow 30. By way of example and not limitation, the radial width of the angled portion 28 is preferably less than half of the radial width of the segments 20.

The angled portions 28 are angled in such a way as to allow the retainer 10 to be readily centered relative to the center of the sleeve 12, and to be pressed onto the sleeve 12 in a first direction opposite that shown for arrow 30. Preferably, the sleeve 12 is sized to fit into the frustoconical region defined by the angled portions 28. Without the angled portions 28, i.e. if the retainer 10 was flat prior to being pressed over the sleeve 12, it would be difficult to align the hole 24 with the sleeve 12 without careful visual alignment. As such, the frustoconical shape provided by the angled portions 28 is advantageous as the retainer 10 can be installed in blind or cramped instances where it is not possible for the installer to see the retainer/sleeve alignment. Once the retainer 10 is pressed onto or over the sleeve, the angled portions 28 ‘dig’ into the sleeve 12 to prevent the retainer 10 from being moved in a second direction comparable to the direction shown by arrow 30, i.e. opposite the first direction. Furthermore, the frustoconical shape provided by the angled portions 28 may be advantageous if fire stop foam or fire stop putty is applied round the sleeve 12 at the point where the sleeve 12 emerges from the opening 14 in the wall 16. That is, there is a space for the foam or putty to go when the retainer 10 is pressed into place if some of that material is sticking out from the wall 16.

The number and relative size of the segments 20 present on the retainer 10 is generally determined by the number and size of slots 48 extending radially from the hole 24. The slots 48 shown in the illustration are relative narrow or thin only for the purpose of an example. Alternatively, the slots may be significantly wider if clearance is needed for a stamping tool that cuts the slots 48 and forms the angled portions 28 in a single operation. If a water jet is used to cut the slots 48, then the slots 48 may be relatively thin or narrow as shown. If the width of the slots 48 are narrower than the thickness of the sheet metal, it may be advantageous for each slot to include a stress relief feature 46 at the end of each slot to help reduce the initiation and/or propagation of fractures. In this non-limiting example, the stress relief feature 46 is a hole with a diameter preferably greater than or equal to the thickness of the sheet metal used to form the retainer 10.

Accordingly, a fire stop retainer (the retainer 10), and a fire stop kit (the kit 40 is provided. The retainer 10 is preferable formed of sheet metal that may be processed using a known water-jet technique, or by stamping, to provide a plurality of segments 20 extending radially inward from the periphery of the body 18. The segments 20 define inner ends 22 of the segments 20 to define a hole 24 or opening in the retainer 10. The size of the hole 24 is selected to create an interference fit with the outer surface 26 of the sleeve 12 to which the retainer 10 is to be assembled. Using the retainer 10 described herein is an inexpensive improvement in reliability over a fire stop system that only includes a sleeve installed in a wall where only hope keeps the sleeve in place. The retainer 10 is also an improvement over other on-site constructed schemes to retain a sleeve in place such as a UNISTRUT® pipe clamp, lag bolts and/or U-bolts as these alternatives typically require on-site power tools, additional material costs, and additional labor costs. Overall, the kit 40 with the retainer 10 described herein has been found to reduce time and material expense when a fire-stop sleeve is needed.

While this invention has been described in terms of the preferred embodiments thereof, it is not intended to be so limited, but rather only to the extent set forth in the claims that follow.

We claim:

1. A press-on retainer configured to retain a fire-stop sleeve in an opening, said retainer comprising:
a body formed of sheet metal, said body configured to define
a concave shape,
a hole in the body, and
a plurality of segments extending radially from the hole, wherein each segment is includes
an angled portion at the end of the segment that defines the hole with a diameter suitable to accept the sleeve, wherein the angled portions are configured to allow the retainer to be pressed onto the sleeve in a first direction, and thereafter prevent the retainer from being moved in a second direction opposite the first direction.

2. The retainer in accordance with claim 1, wherein slots extending radially from the hole define the plurality of segments, and each slot includes a stress relief feature at the end of each slot.

3. A fire-stop kit comprising:
a fire-stop sleeve; and
a press-on retainer configured to retain the sleeve in an opening, wherein said retainer includes
a body formed of sheet metal, said body configured to define
a concave shape,
a hole in the body, and
a plurality of segments extending radially from the hole, wherein each segment is includes
an angled portion at the end of the segment that defines the hole with a diameter suitable to accept the sleeve, wherein the angled portions are configured to allow the retainer to be pressed onto the sleeve in a first direction, and thereafter prevent the retainer from being moved in a second direction opposite the first direction.

4. The fire-stop kit in accordance with claim 3, wherein the kit further comprises a second retainer.
